(19) United States
(12) Patent Application Publication
(10) Pub. No.: US 2002/0163940 A1
(43) Pub. Date: Nov. 7, 2002

(54) Flywheel timing generation method and apparatus for TDMA satellite communications system

(76) Inventors: Junghoon Lee, Potomac, MD (US); Tzeta Tsao, Germantown, MD (US); Lan Ngoc Nguyen, Vienna, VA (US); John Albert Lunsford, Gaithersburg, MD (US)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/811,885

(22) Filed: Mar. 20, 2001

(51) Int. Cl. H04J 3/06; H04B 7/212

(52) U.S. Cl. 370/508; 370/347; 455/42; 455/67.1

(57) ABSTRACT

In a satellite communications system, a flywheel timing value generating method includes generating flywheel timing values based on a satellite drift over a predetermined time. This drift can be a satellite drift in the north/south direction, measured over a sidereal day. By measuring and recording prior drift history in a normal operation, predicted receive and transmit delay times are calculated in order to generate a start of receive control frame and a start of transmit control frame used in a flywheel operation.

### FIELD OF THE INVENTION

This invention relates generally to satellite communications systems, and, more particularly, to a flywheel timing generation method as applicable to TDMA satellite system design and operation.

### BACKGROUND

In time-division multiple access (TDMA), terminals take turns using an entire transmission channel. The terminals transmit according to a frame consisting of a number of time slots, each terminal able to use the entire frequency band of the channel during its assigned time slot. The time slot is measured from a frame marker which repeats at a fixed period, although a time slot can be either fixed or variable in length. The terminals assemble packets for transmitting during their assigned time slots. The transmission can be in the form of bursts having a length of an integer number of slots, the bursts typically consisting of a preamble, a unique word and random symbol data (message portion).

Delay times, or guard times, are placed between the individual slots to assure that the signals from different terminals do not overlap. When the terminals communicate with a common terminal or satellite, the terminals need to be synchronized with the satellite at a tolerance within a fraction of the guard time. The transmission and reception can be on a same channel or on different channels. In a system, multiple terminals communicate with each other to synchronize and correct their assigned start times and delay times, to assure that the time slot allocation is accurately maintained.

A receiving terminal is conventionally used to extract a system clock, and synchronization and timing correction information from a signal transmitted by a satellite. The terminal may include a timing controller that generates system timing based on received signals from the satellite. The timings are usually based on integer multiples of a number of symbols, a symbol being an encoded modulated piece of a larger signal that represents a predetermined number of bits of information. Flywheel timing establishes a synchronization time reference for individual traffic terminals. The synchronization involves a time marker that the traffic terminal uses to align its transmission, the flywheel timing predicting the presence of the synchronization word in received signals based on an anticipated repetition frequency and data pattern for the synchronization word. A terminal may conventionally adjust its system clock when a new synchronization word is received so that the timing of transmitted signals is corrected with respect to the satellite reference clocks. When a flywheel circuit receives the synchronization word at the anticipated times, it determines that synchronization has been established and sends a reference pulse used to control transmissions from individual traffic terminals. The timing controller generates a system clock based on the received signals from the satellite and the reference pulse from the flywheel circuit. Either a symbol clock reference or timing correction information is received from the satellite.

TDMA system timing is generated using an adjustment for satellite ephemeris, or position information. The range change between the satellite and a terminal is conventionally predicted using the ephemeris. Then the TDMA timing of the terminal is accordingly adjusted. To implement this timing method, the ephemeris data should be available at a reference terminal and every traffic terminal. Since the accuracy of the generated TDMA timing depends on the accuracy of the ephemeris data, the ephemeris data needs to be periodically updated to maintain a sufficient timing accuracy. Furthermore, when a terminal loses a reference burst, a separate transmission link should be established to update the ephemeris. Associated data processing and transmission for this updating increase the system complexity and operational cost.

In a TDMA satellite communications system, the timing of every traffic terminal is typically adjusted with reference to the timing of a reference terminal, as shown by way of example in FIG. 4. During normal operation, the receive timing of each traffic terminal is derived from reception of traffic bursts transmitted from the reference terminal. The transmit synchronization is typically achieved by a feedback control process which includes measuring timing offset of a traffic burst at the reference terminal, sending the timing correction information to the traffic terminal, and adjusting the burst transmit timing at the traffic terminal. A reference burst is used for sending the correction information. If, for any reason, the traffic terminal loses a reference burst, neither the receive timing nor the correction information for adjusting the transmit timing is available at the traffic terminal. Thus, there is a need for a method that can be used to support accurate continued system operation by allowing continued generation of the receive and transmit TDMA timings at a traffic terminal, or the receive TDMA timing at a reference terminal, or when the receive reference burst is lost.

### SUMMARY OF THE INVENTION

In view of the deficiencies of conventional systems, it is an object of the present invention to maintain accurate generation of transmit and receive timings at a traffic terminal regardless of whether a receive reference signal is lost. It is an additional object of the present invention to maintain accurate timing at a traffic terminal without a need for an external inputting of satellite ephemeris data.

The present method and apparatus are applicable to conventional user traffic terminals that normally receive their timing synchronization by accessing a reference terminal to correct their individual flywheel timings, and to a flywheel timing generation within the reference terminal. A flywheel timing for satellite communications synchronizes TDMA communications. The flywheel momentum maintains a given accuracy for a period of time with pulses based on the overall rate of reception. The present invention allows the continued generation of the receive and transmit TDMA timings at a traffic terminal, or the receive TDMA timing at a reference terminal, or when the receive reference burst is lost. After an initialization period of normal operation, the present method does not require any external information such as satellite ephemeris, and can maintain sufficient timing accuracy for several hours of flywheel operation. Delay values associated with generating the timings are predicted based on prior drift history, which is generated based on measurements at the terminal during normal system operation. The delay values can be calculated according to a number of different formulas, and various circuit implementations are envisaged. For example, in an INTELSAT system such as that disclosed in IEEE Journal on Selected Areas in Communication, Vol. SAC-1, No. 1, pp. 165-173, an accuracy of at least +/−14 symbols is achieved when measuring over a two-hour flywheel operation.

The present flywheel timing generation method uses the prior history of TDMA timing drift measured at the terminal during normal operation.

The reference terminal derives the transmit timing from its local timing source. However, the reference terminal derives the receive timing from reception of reference bursts. The present method can be used to generate the receive flywheel timing when the reference terminal loses the reference burst.

The satellite range change due to the orbit inclination and eccentricity is periodic with one sidereal day. If an inclination and eccentricity do not change, a flywheel delay value can be obtained by a normal delay value measured one sidereal day prior to the flywheel operation. However, gravitational pull of the sun and the moon at times can change the orbit inclination by 0.005 % per day. Unless there is compensation, the range change due to the inclination change may cause unacceptable timing offset in TDMA system operation. For example, the maximum range difference reaches approximately 420 meters, or 170 symbol periods in the INTELSAT TDMA system, between transmit and receive earth stations, assuming that the earth stations are located at 45° latitude and 45° longitude from the satellite nadir direction. Therefore, to achieve sufficient accuracy, the present method accounts for periodic satellite range change due to the orbit inclination and eccentricity as well as the daily change of the orbit inclination.

The present method includes measuring a satellite drift in the north/south direction at an earth station, generating a history of the measured drift over a period of time, and generating flywheel timing values based on delay values predicted according to the measured satellite drift history over a predetermined time. The predetermined period of time can be one sidereal day. The history of the measured drift can be maintained at the reference terminal as well as at the traffic terminals, so that flywheel timing values can be generated either independently or by sharing of information. The flywheel timing values, for a TDMA satellite communications system having a traffic terminal and a reference terminal, are generated by calculating a number of symbols with respect to reference pulse timing of the traffic terminal. During normal operation, the reference terminal transmits correction information to the traffic terminal. The correction information can include a reference burst used by the traffic terminal to derive a receive timing. Synchronization for transmitting can be achieved by measuring timing offset of a traffic burst at the reference terminal, and adjusting a burst transmit timing at the traffic terminal.

An apparatus according to the invention can include a computer system having a processor and a memory, the memory including software instructions adapted to enable the computer system to perform the steps of: generating a reference pulse stream with a period of one control frame; measuring and recording a plurality of receive time delay and transmit time delay values for a satellite communication signal over a predetermined period of time; designating, for every control frame interval, start of receive frame delay and start of transmit frame delay values based on the control frame period and based on the recorded time delay values, referenced to a designated time, from a designated value for receive frame delay; generating a flywheel receive start timing by counting a calculated number of symbols from a corresponding designated reference pulse; and, from a designated value for start of transmit frame delay, generating a flywheel transmit start timing by counting a calculated number of symbols from a corresponding designated reference pulse.

The computer system can include any means for generating flywheel timing values considering either the daily inclination change, or a daily delay value change, due to a satellite drift in the north/south direction. The daily delay value is computed as a function of a maximum time difference due to the satellite drift in one sidereal day.

A circuit for flywheel operation in a satellite communications system, according to the present invention, includes a first counter that measures a receive delay time during a normal operation, the first counter operative to receive a predicted receive delay value and generate a flywheel receive control timing during flywheeling operation, a second counter that measures a transmit delay time during a normal operation, the second counter operative to receive a predicted transmit delay value and generate a flywheel transmit control timing during flywheeling operation, a first latch operative to record the measured receive delay time, and a second latch operative to record the measured transmit delay time. The circuit can have a symbol clock operative to generate a reference pulse stream.

### BRIEF DESCRIPTION OF THE DRAWING

In the accompanying drawing:

FIG. 1 illustrates the TDMA timing during system operation according to an embodiment of the present invention;

FIG. 2 illustrates TDMA control frame designation for flywheel operation including designation of Start of Receive Control Frames (SORCF) upon loss of receive timing, according to an embodiment of the invention;

FIG. 3A illustrates a circuit configuration during normal operation;

FIG. 3B illustrates a flywheel circuit implementation during flywheeling operation;

FIG. 4 illustrates a general architecture for a satellite communication system that includes a reference terminal sending periodic timing correction information to traffic terminals; and

FIG. 5A illustrates an initialization used in an embodiment of a method according to the present invention;

FIG. 5B illustrates a normal operation phase used in an embodiment of a method according to the present invention

FIG. 6 illustrates an operation upon loss of receive timing, used in an embodiment of a method according to the present invention; and

FIG. 7 illustrates a terminal apparatus according to an embodiment of the present invention.

### DETAILED DESCRIPTION OF THE PREFERRED EMBODIMENT

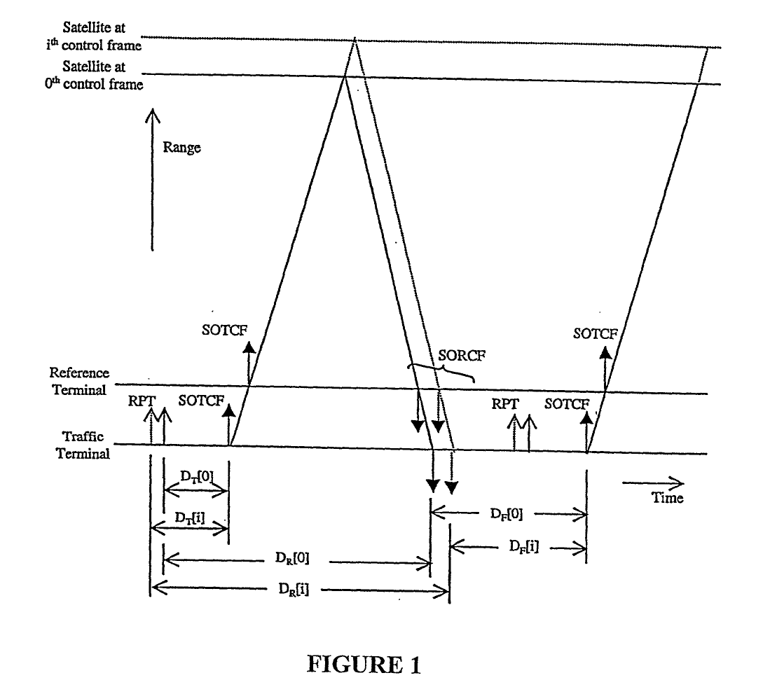

FIG. 1 illustrates the TDMA timing during system operation. The receive timing seen at a traffic terminal drifts over time as the range between the satellite and traffic terminal changes due to satellite motion. In this case, a “control frame” is defined as an integer multiple of a TDMA frame. Timing is measured and adjusted on a control frame basis. During normal operation, receive timing is generated by receiving the reference burst, and transmit timing is generated using a delay value which is provided by the reference terminal. For example, the transmit timing at the i^{th} control frame is generated using D_{F}[i], a delay value provided by the reference terminal for the i^{th} control frame. If the traffic terminal loses a reference burst, the present method generates i^{th} control frame timing using an SORCF (Start of Receive Control Frame) delay value D_{R}[i] and an SOTCF (Start of Transmit Control Frame) delay value D_{T}[i]. The Reference Pulse Timing is represented by RPT. The delay values are generated using various formulas. The delay value D_{R}[i] represents the number of symbols with respect to the reference pulse timing of a traffic terminal at the i^{th} control frame. D_{R}[i] and D_{T}[i] change due to the range change and due to the drift of the traffic terminal clock with respect to the reference terminal clock.

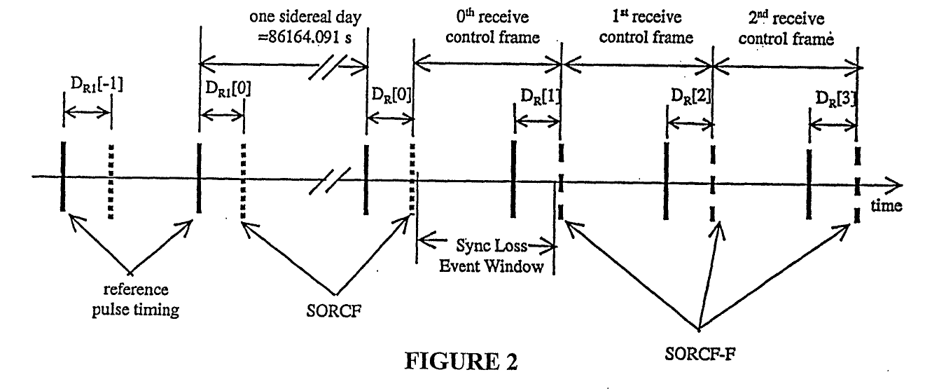

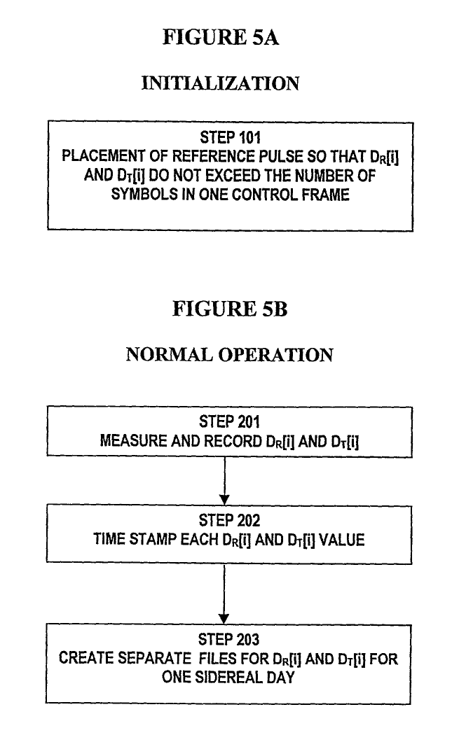

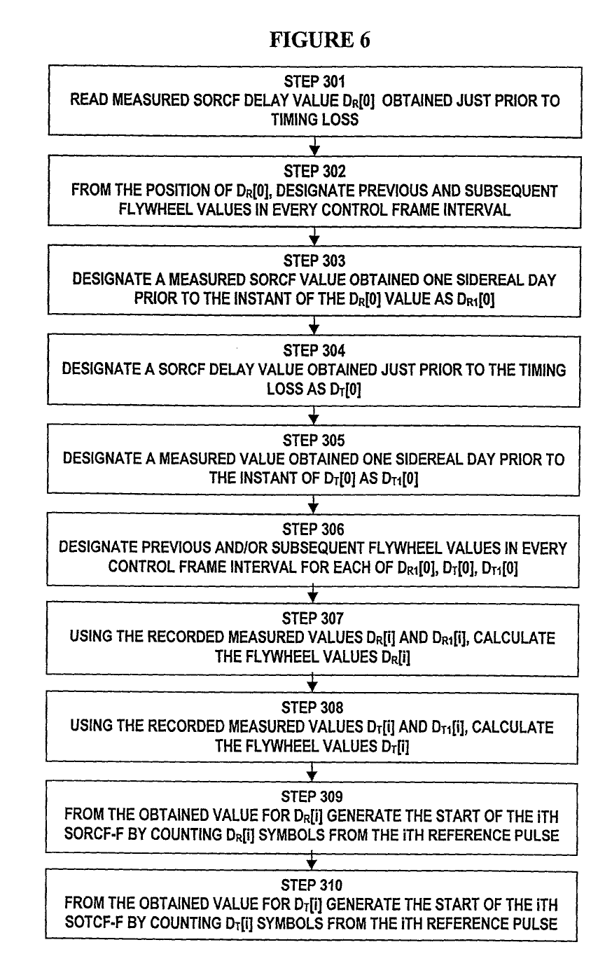

Using the symbol clock, a reference counter at the traffic terminal generates a reference pulse stream with a period of one control frame. The approximate location of the reference pulse is established relative to the SORCF to facilitate the flywheel timing generation. An exemplary embodiment of a flywheel timing generation method is shown in FIGS. 5A, 5B, and 6. At network initialization, the reference pulse is appropriately placed such that D_{R}[i] and D_{T}[i] values do not exceed the number of symbols in one control frame during the system operation, Step 101. During normal operation, D_{R}[i] and D_{T}[i] are measured and recorded, Step 201. A time stamp is put on each D_{R}[i] and D_{T}[i] value, Step 202. A file of D_{R}[i] values is created for one sidereal day (86164.091 seconds) plus 4N_{τ}T_{c} seconds, Step 203, where T_{c} denotes a control frame period in seconds and N_{τ} denotes an integer parameter that is optimized for a required flywheel duration. The integer N_{τ} can be experimentally derived and changed either by an operator or automatically according to a history file, or according to a predetermined condition. Typical values for 4N_{τ}T_{c} are around 7200 seconds and do not exceed 21600 seconds. A file of D_{T}[i] values is created for one sidereal day, Step 203. In the event of loss of receive timing, SORCF delay values are designated for flywheel operation. FIG. 1 and FIG. 2 illustrate an example of this designation of SORCF delay values. A measured SORCF delay value D_{R}[0], obtained just prior to the timing loss, is used as a reference, Step 301. From this position D_{R}[0], previous measured values and subsequent flywheel values are designated as D_{R}[i], (i=−4N_{τ}, . . . −2, −1, 0, 1, 2 . . .) in every control frame interval, Step 302. A measured SORCF value, obtained one sidereal day prior to the instant of the D_{R}[0] measurement, is designated as D_{R1}[0], Step 303. From this position at D_{R1}[0], previous and subsequent measured values are designated as D_{R1}[i], (i=−4N_{τ}, . . . −2, −1, 0, 1, 2, . . . ) in every control frame interval, Step 306. A measured SORCF delay value, obtained just prior to the timing loss, is designated as D_{T}[0], Step 304. From the position at D_{T}[0], subsequent flywheel values are designated as D_{T}[i], (i=−4N₉₆ , . . . −2, −1, 0, 1, 2, . . . ) in every control frame interval, Step 306. A measured value, obtained one sidereal day prior to the instant of the D_{T}[0] measurement, is designated as D_{T1}[0], Step 305. From this position at D_{T1}[0], previous and subsequent measured values are designated as D_{T1}[i], (i=−4N_{τ}, . . . −2, −1, 0, 1, 2, . . . ) in every control frame interval, Step 306. The flywheel values used to generate receive timing are calculated using a flywheel timing generating equation derived on the basis of a model that approximates the daily delay value change due to the satellite drift and that assumes a satellite range change being sinusoidal with one sidereal period. Several non-limiting variations for a flywheel timing generating equation are detailed below. It is understood that one skilled in the art can use approximations other than those illustrated for deriving alternative computations for a daily delay value change. In a first example, using the recorded measured values D_{R1}[i] and D_{R}[i], the flywheel values D_{R}[i] (i=1, 2, . . . ) are calculated, Step 307, by

D_{R}[i]=D_{R1}[i]+D_{R}[−2N_{τ}]−D_{R1}[−2N_{τ}]+INT[(T_{sd}/4πN_{τ}T_{c}){D_{R}[−N_{τ}]−D_{R1}[−N_{τ}]−D_{R}[3N_{τ}]+D_{R1}[3N_{τ}]}sin{2π(T_{c}/T_{sd})(i+2N_{τ})}]+INT[(T_{sd}/4πN_{τ}T_{c})²{D_{R}[0]−D_{R1}[0]−D_{R}[−4N_{τ}]+D_{R1}[−4N_{τ}]−2D_{R}[−3N_{τ}]+2D_{R1}[−3N_{τ}]}•[1−cos{2π(T_{c}/T_{sd})(i+2N_{τ})}]].

where T_{sd}, T_{c}, and INT[•] respectively denote one sidereal day duration, control frame period, and the nearest integer. For example, INT[1.6]=2; INT[1.3]=1; and INT[1.5]=2. Using the recorded measured values D_{T1}[i] and D_{T}[i], the flywheel values D_{T}[i] (i=1, 2, . . . ) can be calculated, Step 308, for example, by

D_{T}[i]=D_{T1}[i]+D_{T}[−2N_{τ}]−D_{T1}[−2N_{τ}]+INT[(T_{sd}/4πN_{τ}T_{c}){D_{T}[−N_{τ}]−D_{T1}[−N_{τ}]−D_{T}[3N_{τ}]+D_{T1}[3N_{τ}]}sin{2π(T_{c}/T_{sd})(i+2N_{τ})}]+INT[(T_{sd}/4πN_{τ}T_{c})²{D_{T}[0]−D_{T1}[0]−D_{T}[−4N_{τ}]+D_{T1}[−4N_{τ}]−2D_{T}[−3N_{τ}]+2D_{T1}[−3N_{τ}]}•[1−cos{2π(T_{c}/T_{sd})(i+2N_{τ})}]].

A derivation of these exemplary equations is shown below. From the obtained values for D_{R}[i] and D_{T}[i], the traffic terminal generates receive and transmit timings. Start of i^{th} SORCF-F (flywheel SORCF) is generated by counting D_{R}[i] symbols from the i^{th} reference pulse, Step 309. Start of i^{th} SOTCF-F (flywheel SOTCF) is generated by counting D_{T}[i] symbols from the i^{th} reference pulse, Step 310.

It will understood by one of ordinary skill in the art that the exemplary method described herein can be implemented in part or as a whole, and that the identification of individual steps is non-limiting. A use of the invention in any appropriate programming language is envisaged, and the method may be employed by any suitable hardware, including a stand-alone terminal or processor, multiple processor configuration, or in a network.

A terminal utilizing the present method can be a simple telephone terminal or a complex multichannel system including local area networks (LAN) or wide area networks (WAN) within its control.

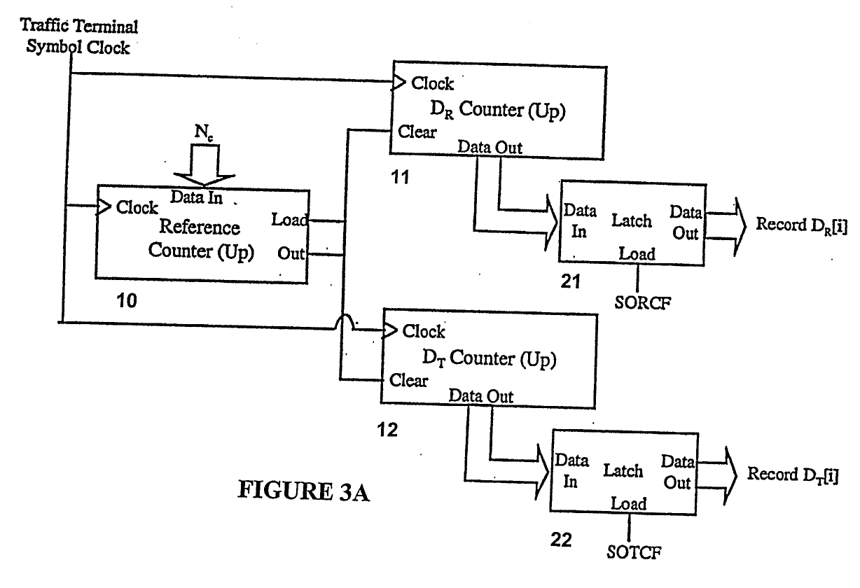

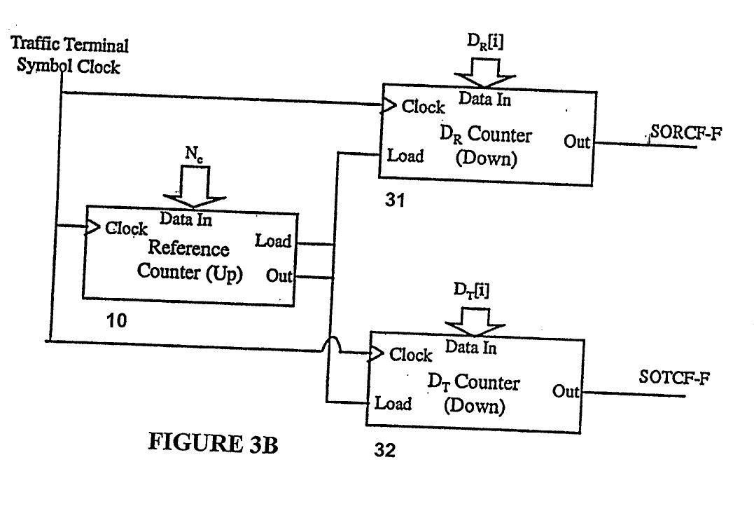

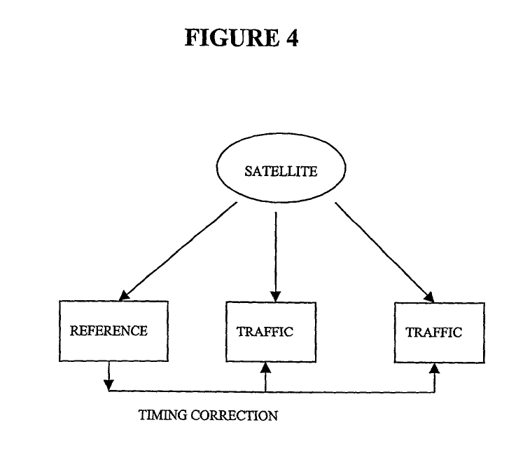

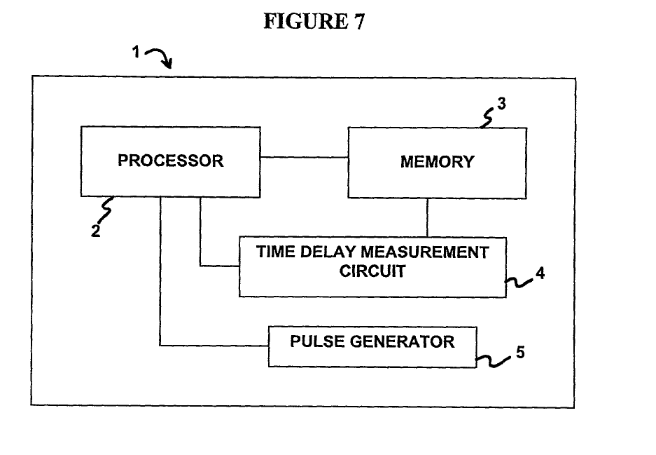

FIG. 7 illustrates a terminal 1 used to implement a flywheel timing generation method. The terminal 1 can include a computer system having a processor 2 and a memory 3, the memory 3 including software instructions adapted to enable the computer system to perform the steps of: generating a reference pulse stream with a period of one control frame; measuring and recording a plurality of receive time delay and transmit time delay values for a satellite communication signal over a predetermined period of time; designating, for every control frame interval, start of receive frame delay and start of transmit frame delay values based on the control frame period and based on the recorded time delay values, referenced to a designated time, from a designated value for receive frame delay; generating a flywheel receive start timing by counting a calculated number of symbols from a corresponding designated reference pulse; and, from a designated value for start of transmit frame delay, generating a flywheel transmit start timing by counting a calculated number of symbols from a corresponding designated reference pulse. The time delay measurement circuit 4 can comprise counters and latches, as shown in FIGS. 3A, 3B. The pulse generator 5 can supply a system clock, a reference pulse stream, flywheel receive start timing pulses, flywheel transmit start timing pulses, synchronization words, as well as timing control information.

The computer system will typically have a 32-bit, or larger, microprocessor interface, with a data interface able to accept communications that include serial, parallel, and synchronous or having a timecode interface. The computer system also has a data output adaptable to generating frame data structures that include flywheel frames. The computer may be implemented using very large scale integrated circuit (VLSI) components of various protocols, and can be arranged as subsystems that are specific to a certain data format or optimized for various error detection, coding schemes, or transfer rates.

Flywheel Circuit Implementation

An exemplary embodiment of a circuit implementation for flywheel operation is illustrated in FIGS. 3A and 3B. The circuit operation is described as follows.

Using a symbol clock of a traffic terminal, a reference pulse stream with a period of one control frame is generated. During normal operation, the circuit is configured as shown in FIG. 3A. D_{R} and D_{T} values are measured by the respective UP counters 11, 12. Then, using the respective latches 21, 22, D_{R} and D_{T} values are recorded. During flywheel operation, the circuit is configured as shown in FIG. 3B. The predicted D_{R} and D_{T} values are sent to the respective DOWN counters 31, 32. Then, from these DOWN counters, the SORCF-F and SOTCF-F flywheel timings are generated. The symbol N_{c} represents the number of symbols in one control frame.

Flywheel Timing Generation Example

To better illustrate the present method, an example is now provided for generating flywheel timing in an application to the INTELSAT TDMA system. For two hours of flywheel operation, a simulation indicates that an optimum value of NT is equal to 1800. Substituting N_{τ}=1800 into the above equation for determining the flywheel values D_{R}[i], and rearranging terms provides an SORCF flywheel generating equation:

D_{R}[i]=D_{R1}[i]+A₁+INT[A₂ sin{7.467×10⁻⁵(i+3600)}+A₃(1−cos{7.467×10⁻⁵(i+3600)})],

where

A₁=D_{R}[0]−D_{R1}[0],

A₂=3.72(D_{R}[−1800]−D_{R1}[−1800]−D_{R}[−5400]+D_{R1}[−5400]), and

A₃=13.8385(D_{R}[0]−D_{R1}[0]+D_{R}[−7200]−D_{R1}[−7200]−2D_{R}[−3600]+2D_{R1}[−3600]);

likewise, an SOTCF flywheel value generating equation becomes:

D_{T}[i]=D_{T1}[i]+B₁+INT[B₂ sin{7.467×10⁻⁵(i+3600)}+B₃(1−cos{7.467×10⁻⁵(i+3600)})],

where

B₁=D_{T}[0]−D_{T1}[0],

B₂=3.72(D_{T}[−1800]−D_{T1}[−1800]−D_{T}[−5400]+D_{T1}[−5400]), and

B₃=13.8385(D_{T}[0]−D_{T1}[0]+D_{T}[−7200]−D_{T1}[−7200]−2D_{T}[−3600]+2D_{T1}[−3600]).

In such an example, the inventors' experimental computer simulation results, which include quantization and approximation errors, indicate that an accuracy of +/−14 symbols is achieved during a two-hour flywheel period for both SORCF and SOTCF.

Derivation of a Flywheel Value Generating Equation

Referring to FIG. 1, a SORCF delay value changes in accordance with the range of the reference terminal to satellite plus the satellite to traffic terminal. A satellite range change due to orbit inclination and eccentricity is periodic over time with one sidereal day period. Therefore, if the orbit inclination and eccentricity do not change in a day, a delay value at a certain time can be given by that of one sidereal day prior to that time. However, the orbit inclination changes during a day. Therefore, the flywheel value generating equation is derived considering the daily inclination change due to the satellite drift in the north/south direction. The east/west satellite drift is ignored because the impact on the range change is much smaller than that of the north/south drift.

Since a satellite range change is sinusoidal with one sidereal period, the daily delay value change due to the satellite drift, Z(t), can be approximately modeled by:

$$\begin{matrix}Z ( t ) ≡ {D}_{R} ( t ) - {D}_{R1} ( t ) \\ = {K}_{1} sin ( 2 π t / {T}_{sd} + θ ) + {K}_{2} ,\end{matrix}$$

where:

D_{R}(t) denotes the time difference between the reference pulse and SORCF,

D_{R1}(t) denotes the time difference between the reference pulse and SORCF at one sidereal day prior to a time t,

K₁ denotes the maximum time difference due to the satellite drift in one sidereal day,

K₂ denotes the timing difference due to the traffic terminal clock drift with respect to the reference terminal clock,

T_{sd} denotes one sidereal day, i.e., 86164.091 seconds, and

θ denotes a random phase associated with the daily delay change.

Using this definition of the daily delay value change due to the satellite drift, Z(t), a predicted value, D_{R}(t₀+Δt), can be written as:

D_{R}(t₀+Δt)=D_{R1}(t₀+Δt)+D_{R}(t₀)−D_{R1}(t₀)+Z(t₀+Δt)−Z(t₀).

The term Z(t+Δt)−Z(t) can be written as:

Z(t+Δt)−Z(t)=(T_{sd}/2π) sin(2πΔt/T_{sd})d/dt Z(t)−(T_{sd}/2π)²{1−cos(2πΔt/T_{sd})}d²/dt²Z(t).

For Δτ<<T_{sd},

d/dt Z(t₀)≈{Z(t₀+Δτ/2)−Z(t₀−Δτ/2)}/Δτ,

and

$$\begin{matrix}{ⅆ}^{2} / ⅆ {t}^{2} Z ( {t}_{0} ) \approx \{ ⅆ / ⅆ t Z ( {t}_{0} + Δτ / 2 ) - ⅆ / ⅆ t Z ( {t}_{0} - Δτ / 2 ) \} / Δτ \\ \approx \{ Z ( {t}_{0} + Δτ ) + Z ( {t}_{0} - Δ τ ) - 2 Z ( {t}_{0} - Δτ / 2 ) \} / {Δτ}^{2} .\end{matrix}$$

In addition, Z(t₀+Δτ)−Z(t₀−Δτ) can be represented as follows:

Z(t₀+Δτ)−Z(t₀−Δτ)≈(T_{sd}/2πΔτ){Z(t₀+Δτ/2)−Z(t₀−Δτ/2)}sin(2πΔt/T_{sd})+(T_{sd}/2πΔτ)²{Z(t₀+Δτ)+Z(t₀−Δτ)−2Z(t₀−Δτ/2)}{1−cos(2πΔt/T_{sd})}.

Putting the representation for Z(t₀+Δτ)−Z(t₀−Δτ) into the predicted value D_{R}(t₀+Δt) and using the definition of Z(t), the flywheel timing generating equation is given by:

D_{R}(t₀+Δt)=D_{R1}(t₀+Δt)+D_{R}(t₀)−D_{R1}(t₀)+(T_{sd}/2πΔτ){Z(t₀+Δτ/2)−Z(t₀−Δτ/2)}sin(2πΔt/T_{sd})+(T_{sd}/2πΔτ)²{Z(t₀+Δτ)+Z(t₀−Δτ)−2Z(t₀−Δτ/2)}{1−cos(2πΔt/T_{sd})}=D_{R1}(t₀+Δt)+D_{R}(t₀)−D_{R1}(t₀)+(T_{sd}/2πΔτ){D_{R}(t₀+Δτ/2)−D_{R1}(t₀+Δτ/2)−D_{R}(t₀−Δτ/2)+D_{R1}(t₀−Δτ/2)}sin(2πΔt/T_{sd})+(T_{sd}/2πΔτ)²{D_{R}(t₀+Δτ)−D_{R1}(t₀+Δτ)−D_{R}(t₀−Δτ)+D_{R1}(t₀−Δτ)−2D_{R}(t₀−Δτ/2)+2D_{R1}(t₀−Δτ/2)}{1−cos(2πΔt/T_{sd})}.

By using this equation, D_{R}(t₀+Δt) can thus be calculated from D_{R}(t), t≦t₀+Δτ, and D_{R1}(t), t≦t₀+Δτ. In other words, D_{R}(t), t≦t₀+Δτ, can be predicted using previous values of D_{R}(t) and D_{R1}(t), assuming that Δt is not greater than T_{sd}+Δτ. At a traffic terminal, the time difference between the reference pulse and SORCF is measured once every control frame. The time difference can be expressed, for example, as a number of symbol periods. In association with the flywheel timing generating equation, the measured values are defined by:

D_{R}[i]≡INT[D_{R}(t₀+Δτ+i•T_{c})/Tₛ],

D_{R1}[i]≡INT[D_{R1}(t₀+Δτ+i•T_{c})/Tₛ], and

Δτ≡2•N_{τ}•T_{c},

where Tₛ is the symbol period. Then, the SORCF flywheel timing generating equation can be written as:

D_{R}[i]=D_{R1}[i]+D_{R}[−2N_{τ}]−D_{R1}[−2N_{τ}]+INT[(T_{sd}/2πN_{τ}T_{c}){D_{R}[−N_{τ}]−D_{R1}[−N_{τ}]−D_{R}[3N_{τ}]+D_{R1}[3N_{τ}]}sin{2π(T_{c}/T_{sd})(i+N_{τ})}]+INT[(T_{sd}/2πN_{τ}T_{c})²{D_{R}[0]−D_{R1}[0]−D_{R}[−4N_{τ}]+D_{R1}[−4N_{τ}]−2D_{R}[−3N_{τ}]+2D_{R1}[−3N_{τ}]}[1−cos{2π(T_{c}/T_{sd})(i+N_{τ})}]].

This algorithm compensates flywheel timing offset due to the traffic terminal clock drift with respect to the reference terminal clock since the term D_{R1}(t₀+Δτ)−D_{R1}(t₀) in the flywheel timing generating equation compensates the time offset generated for a duration of Δt.

The SOTCF delay value can also be accurately deduced. For TDMA synchronization, the timing seen at the satellite should be synchronized. The SOTCF delay value changes in accordance with the range of the reference terminal to satellite minus the range from the satellite to traffic terminal. Since the range change is sinusoidal over time with one sidereal day period, the daily SOTCF delay value due to the satellite drift in the north/south direction can be determined by using the same daily delay value change due to the satellite drift, Z(t), modeled as noted above. Therefore, by using the SORCF flywheel timing generating equation just described for the SORCF delay value, the SOTCF flywheel value generating equation can be written as:

D_{T}[i]=D_{T1}[i]+D_{T}[−2N_{τ}]−D_{T1}[−2N_{τ}]+INT[(T_{sd}/2πN_{τ}T_{c}){D_{T}[−N_{τ}]−D_{T1}[−N_{τ}]−D_{T}[3N_{τ}]+D_{T1}[3N_{τ}]}sin{2π(T_{c}/T_{sd})(i+N_{τ})}]+INT[(T_{sd}/2πN_{τ}T_{c})²{D_{T}[0]−D_{T1}[0]−D_{T}[−4N_{τ}]+D_{T1}[−4N_{τ}]−2D_{T}[−3N_{τ}]+2D_{T1}[−3N_{τ}]}[1−cos{2π(T_{c}/T_{sd})(i+N_{τ})}]].

Thus, a flywheel timing generation method, circuit, and computer system are provided for a satellite communications system. One skilled in the art will appreciate that the present invention can be practiced by other than the described embodiments, which are presented for purposes of illustration and not limitation, and the present invention is limited only by the claims that follow.

What is claimed is:

1. A method for satellite communications, comprising:
measuring a satellite drift in the north/south direction at an earth station;
generating a history of the measured drift over a period of time; and
generating flywheel timing values based on delay values predicted according to the measured satellite drift history over a predetermined time.

2. A method as claimed in claim 1, wherein the predetermined period of time is one sidereal day.

3. A method as claimed in claim 1, wherein the generated flywheel timing values are used in a time division multiple access (TDMA) satellite communications system.

4. A method as claimed in claim 1, further comprising continuously generating, based on the generated flywheel timing values, at least one of receive and transmit TDMA timings at a traffic terminal, receive TDMA timing at a reference terminal, and TDMA timing when a receive reference burst is lost.

5. A method as claimed in claim 1, wherein the generating comprises predicting delay values used for at least one of transmit timing, receive timing, and reference pulse timing.

6. A method as claimed in claim 5, wherein the earth station is one of a traffic terminal and a reference terminal.

7. A method as claimed in claim 1, wherein the flywheel timing values, for a TDMA satellite communications system having a traffic terminal and a reference terminal, are generated by calculating a number of symbols with respect to reference pulse timing of the traffic terminal.

8. A method as claimed in claim 7, further comprising, during normal operation, the reference terminal transmitting correction information to the traffic terminal.

9. A method as claimed in claim 8, wherein the correction information comprises a reference burst used by the traffic terminal to derive a receive timing.

10. A method as claimed in claim 8, farther comprising synchronizing the transmitting by measuring timing offset of a traffic burst at the reference terminal, and adjusting a burst transmit timing at the traffic terminal.

11. A method as claimed in claim 4, wherein the continuous generating of TDMA timing comprises generating control frame timing based on a calculated start of receive control frame delay value and a calculated start of transmit control frame delay value.

12. A method as claimed in claim 11, wherein the delay values are compensated according to at least one of a range change and a drift of a traffic terminal clock with respect to a reference terminal clock.

13. A flywheel timing generation method, comprising:
generating a reference pulse stream with a period of one control frame;
measuring and recording a plurality of receive time delay and transmit time delay values for a satellite communication signal over a predetermined period of time;
designating, for every control frame interval, start of receive frame delay and start of transmit frame delay values based on the control frame period and based on the recorded time delay values, referenced to a designated time;
from a designated value for receive frame delay, generating a flywheel receive start timing by counting a calculated number of symbols from a corresponding designated reference pulse;
from a designated value for start of transmit frame delay, generating a flywheel transmit start timing by counting a calculated number of symbols from a corresponding designated reference pulse.

14. A method for satellite communications, comprising:
measuring and recording a plurality of timing delay values at an earth station for a period of time; and
generating flywheel timing values by calculating a satellite range change based on the recorded delay values, the range change predicted to compensate a satellite drift in the north/south direction over a predetermined time.

15. A method as claimed in claim 14, wherein the predetermined period of time is one sidereal day.

16. A method as claimed in claim 14, wherein the generated flywheel timing values are used in a time division multiple access (TDMA) satellite commnunications system.

17. A method as claimed in claim 14, further comprising continuously generating, based on the generated flywheel timing values, at least one of receive and transmit TDMA timings at a traffic terminal, receive TDMA timing at a reference terminal, and TDMA timing when a receive reference burst is lost.

18. A method as claimed in claim 14, wherein the generating comprises predicting delay values used for at least one of transmit timing, receive timing, and reference pulse timing.

19. A computer system used for satellite communications, comprising:
a processor; and
a memory including software instructions adapted to enable the computer system to perform the steps of:
generating a reference pulse stream with a period of one control frame;
measuring and recording a plurality of receive time delay and transmit time delay values for a satellite communication signal over a predetermined period of time;
designating, for every control frame interval, start of receive frame delay and start of transmit frame delay values based on the control frame period and based on the recorded time delay values, referenced to a designated time;
from a designated value for receive frame delay, generating a flywheel receive start timing by counting a calculated number of symbols from a corresponding designated reference pulse;
from a designated value for start of transmit frame delay, generating a flywheel transmit start timing by counting a calculated number of symbols from a corresponding designated reference pulse.

20. A computer system used for satellite communications, comprising:
a processor; and
means for generating flywheel timing values considering the daily inclination change due to a satellite drift in the north/south direction.

21. A computer system used for satellite communications, comprising:
a processor; and
means for generating flywheel timing values considering a daily delay value change for received and transmitted signals due to satellite drift in the north/south direction.

22. A computer system as claimed in claim 21, wherein said daily delay value is computed as a function of a maximum time difference due to the satellite drift in one sidereal day.

23. A circuit for flywheel operation in a satellite communications system, comprising:
a first counter operative to measure a receive delay time during a normal operation, the first counter operative to receive a predicted receive delay value and generate a flywheel receive control timing during flywheeling operation;
a second counter operative to measure a transmit delay time during a normal operation, the second counter operative to receive a predicted transmit delay value and generate a flywheel transmit control timing during flywheeling operation;
a first latch operative to record the measured receive delay time; and
a second latch operative to record the measured transmit delay time.

24. A circuit as claimed in claim 22, further comprising a symbol clock operative to generate a reference pulse stream.

25. A satellite communications system having a satellite, at least one reference terminal, and a plurality of traffic terminals in communication with the reference terminal for transferring timing correction information between the terminals, the system comprising:
a timing correction signal generator in the satellite for transmitting the timing correction information to the reference terminal; and
a flywheel timing generator operative to generate flywheel timing signals when the timing correction information transmitted by the satellite is not available to the reference terminal,
wherein the flywheel timing generator generates the flywheel timing signals based on at least one of a daily inclination change due to a satellite drift in the north/south direction and a daily delay value change for received and transmitted signals due to satellite drift in the north/south direction.
